(19) United States
(12) Patent Application Publication
(10) Pub. No.: US 2010/0175016 A1
(43) Pub. Date: Jul. 8, 2010

(54) Security key inputting system for touch screen device

(76) Inventors: Wei Cheng Tian, Shanghai (CN); Yi Dong, Shanghai (CN)

Correspondence Address: Raymond Y. Chan, Suite 128, 108 North Ynez Avenue, Monterey Park, CA, 91754, US

(21) Appl. No.: 12/319,466

(22) Filed: Jan. 6, 2009

(51) Int. Cl. G06F 3/048; G06F 3/041

(52) U.S. Cl. 715/773; 345/173

(57) ABSTRACT

A touch screen device includes a touch screen panel having a key input area and defining a plurality of touch-sensitive keys at the key input area, a control module operatively linking with the touch screen panel, and a security key inputting system operatively linked to the control module. The control module displays a plurality of input characters at the touch-sensitive keys respectively in such a manner that when one of the touch-sensitive keys is contacted, the control module identifies the corresponding input character being selected as an input data. The security key inputting system is arranged for randomly re-arranging the input characters at different touch-sensitive keys respectively, wherein the input characters are alternately displayed at the touch-sensitive keys for preventing the input characters from being read by memorization of fixed location.

### BACKGROUND OF THE PRESENT INVENTION

1. Field of Invention

The present invention relates to a touch screen device, and more particularly to a security key inputting system for the touch screen device, which is arranged to randomly re-arranging the input characters at different touch-sensitive keys respectively, such that the input characters are alternately displayed at the touch-sensitive keys for preventing the input characters from being read by memorization of fixed location.

2. Description of Related Arts

A traditional keyboard comprises a plurality of functional keys for data input. The major drawback of the keyboard is that all the functional keys are fixed at their locations. Therefore, when the user input the date through the functional keys, a person around the user is able to rear the data by memorization of the fixed location. In addition, other advanced detecting device can read the locations of the functional keys to be used, such as fingerprint detection. Therefore, it is unsafe for the user to use the traditional keyboard for data input, such as entering the PIN number from the ATM.

### SUMMARY OF THE PRESENT INVENTION

A main object of the present invention is to provide a security key inputting system for the touch screen device, which is arranged to randomly re-arranging the input characters at different touch-sensitive keys respectively, such that the input characters are alternately displayed at the touch-sensitive keys for preventing the input characters from being read by memorization of fixed location.

Another object of the present invention is to provide a security key inputting system for the touch screen device, wherein an activation key is assigned to be activated for randomly re-locating the input characters at the touch-sensitive keys respectively.

Another object of the present invention is to provide a security key inputting system, which can be incorporated with the touch screen device or a traditional keyboard.

Accordingly in order to accomplish the above objects, the present invention provides a touch screen device, comprising:

a touch screen panel having a key input area and defining a plurality of touch-sensitive keys at the key input area;

a control module operatively linking with the touch screen panel for displaying a plurality of input characters at the touch-sensitive keys respectively in such a manner that when one of the touch-sensitive keys is contacted, the control module identifies the corresponding input character being selected as an input data; and

a security key inputting system, which is operatively linked to the control module, randomly re-arranging the input characters at different touch-sensitive keys respectively, wherein the input characters are alternately displayed at the touch-sensitive keys for preventing the input characters from being read by memorization of fixed location.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating the configuration of a touch screen device incorporating with a security key inputting system according to a preferred embodiment of the present invention.

FIG. 2 illustrates an initial display of the touch screen panel according to the above preferred embodiment of the present invention.

FIG. 3 illustrates the re-location of the input characters on the touch screen panel according to the above preferred embodiment of the present invention.

FIGS. 4A and 4B illustrate an alternative mode of the activation key for the touch screen panel according to the above preferred embodiment of the present invention.

### DETAILED DESCRIPTION OF THE PREFERRED EMBODIMENT

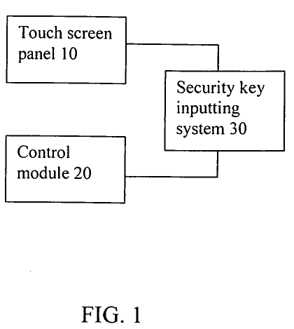

Referring to FIG. 1 of the drawings, a touch screen device according to a preferred embodiment of the present invention is illustrated, wherein the touch screen device, such as an existing touch screen module, comprises a touch screen panel 10 and a control module 20.

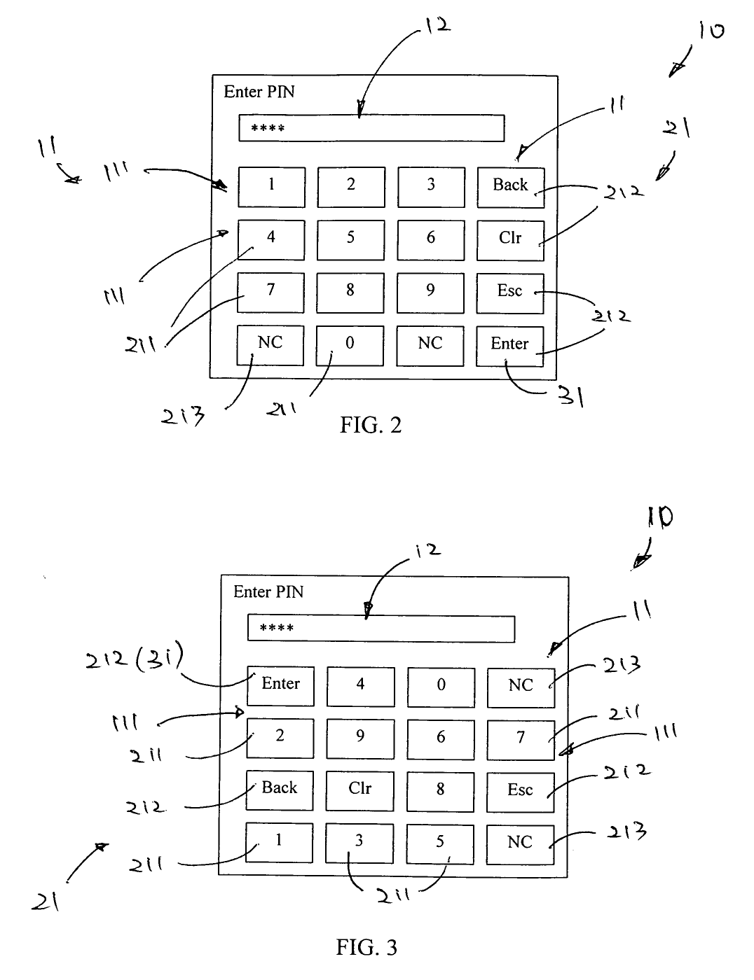

As shown in FIG. 2, the touch screen panel 10 has a key input area 11 and defining a plurality of touch-sensitive keys 111 at the key input area 11.

The control module 20 is operatively linking with the touch screen panel 10 for displaying a plurality of input characters 21 at the touch-sensitive keys 111 respectively in such a manner that when one of the touch-sensitive keys 111 is contacted, the control module 20 identifies the corresponding input character 21 being selected as an input data.

Accordingly, in order to input the corresponding input character 21, the user is able to contact the corresponding touch-sensitive key 111 by the finger tip or a touch-sensitive pen. For example, when a PIN number “1245” is needed to be input, the user is able to touch on the key input area 11 with the corresponding input characters 21 of “1”, “2”, “4”, and “5” orderly at the touch-sensitive keys 111.

As shown in FIG. 2, the input characters 21 are displayed at the touch-sensitive keys 111 respectively in a traditional manner, such that when the user inputs the PIN number, people around the user may read the PIN number by memorization of fixed location.

The present invention provides a security key inputting system 30 to incorporate with the control module 20 to enhance the security level of the touch screen device. Accordingly, the security inputting system 30 is operatively linked between the touch screen panel 10 and the control module 20, wherein the security inputting system 30 is randomly re-arranging the input characters 21 at different touch-sensitive keys 111 respectively. Therefore, the input characters 21 are alternately displayed at the touch-sensitive keys 111 for preventing the input characters 21 from being read by memorization of fixed location.

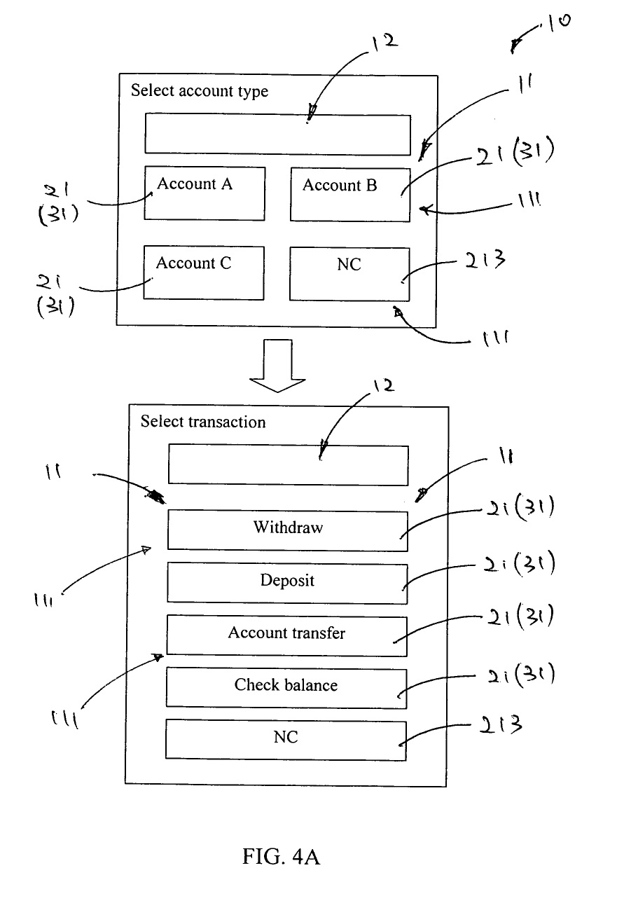

As shown in FIG. 3, the input characters 21 are re-located at the touch-sensitive keys 111 such that when the user inputs the same PIN number, the user must contact the corresponding input characters 21 at different touch-sensitive keys 111. It is worth mentioning that the security inputting system 30 is randomly re-arranging the input characters 21 in a manner that one of the input characters 21 may re-locate at the same previous location of the touch-sensitive key 111. However, the rest of the input characters 21 will be re-located at the different locations of the touch-sensitive keys 111. In other words, the user will input the same PIN number at different locations of the touch-sensitive key 111 every time during operation.

By incorporating with the security key inputting system 30, the present invention further provides a security key inputting method for the touch screen device, comprising the following steps.

(1) Initially display the input characters 21 at the touch-sensitive keys 111 at the key input area 11 of the touch screen panel 10 respectively. Accordingly, each of the input characters 21 is displayed at the initial location of the respective touch-sensitive key 111.

(2) Periodically and randomly re-arrange the input characters 21 at different touch-sensitive keys 111 respectively.

(3) Re-locate the input characters 21 at different touch-sensitive keys 111 respectively. Therefore, the input characters 21 are alternately displayed at the touch-sensitive keys 111 for preventing the input characters 21 from being read by memorization of fixed location.

According to the preferred embodiment, the touch screen device provides a password interface on the touch screen panel 10 for the user to input the PIN number. The input characters 21 are numerical keys 211 from 0 to 9, functional keys 212, and one or more blank keys 213. Accordingly, all the numerical keys 211, functional keys 212, and blank keys 213 are arranged to be re-located at different touch-sensitive keys 111, as shown in FIGS. 2 and 3. It is appreciated that the security key inputting system 30 is adapted to re-arrange the numerical keys 211 only, or the numerical keys 211 and the blank keys 213 only without re-locating the functional keys 212. In addition, the blank keys 213 are non-operating keys that no input data is read by the control module 20 when the blank keys 213 are contacted. However, the blank keys 213 provide more combinations for relocating the numerical keys 211 and the functional keys 212.

The security key inputting system 30 comprises an activation key 31 operatively linked with one of the input characters 21 to be displayed at one of the touch-sensitive keys 111 and arranged in such a manner that when the activation key 31 is activated by a contact of the corresponding touch-sensitive key 111, the input characters 21 are randomly re-located at the touch-sensitive keys 111 respectively. Accordingly, the period of randomly re-arranging the input characters 21 is the contact of the activation key 31.

Using the above mentioned password interface as an example, the activation key 31 is assigned as an “ENTER” key of the input character 21, such that when the “ENTER” key is contacted, all the input characters 21 are randomly re-located at the touch-sensitive keys 111 respectively.

There are two possible results for the PIN input. The first result is that when the PIN number is correctly input, the next accessing interface will be displayed on the touch screen panel 10. Therefore, once the “ENTER” key as the activation key 31 is contacted to confirm the PIN number, the input characters 21 will be re-arranged to re-locate at different touch-sensitive keys 111 on the next accessing interface on the touch screen panel 10. The second result is that when the PIN number is incorrectly input, the password interface is re-loaded for the user to re-input the PIN number. Therefore, once the “ENTER” key as the activation key 31 is contacted, the input characters 21, especially the numerical keys 211, will be re-arranged to re-locate at different touch-sensitive keys 111 on the password interface on the touch screen panel 10, as shown in FIG. 3.

As shown in FIGS. 2 and 3, the touch screen panel 10 further has a key display area 12 provided at a position adjacent to the key input area 11. The key display area 12 of the touch screen panel 10 is arranged for displaying the input characters 21 at the touch-sensitive keys 111 being contacted. For enhancing the security level, the input character 21 is converted as a hidden symbol, such as “*”, to be displayed at the key display area 12. For example, when the user touches on the key input area 11 with the four input characters 21 of “1”, “2”, “4”, and “5” orderly at the touch-sensitive keys 111, the key display area 12 will show “****” to illustrate the numbers of input characters 21 being input.

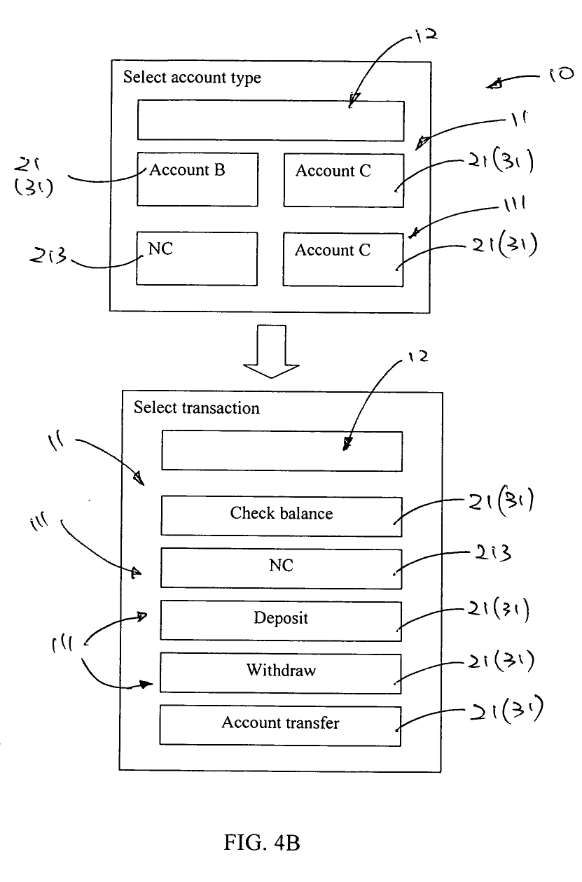

FIGS. 4A and 4B illustrates an alternative mode of the security key inputting system 30 as another example of the present invention. Accordingly, the touch screen device provides a list of option interface on the touch screen panel 10 for the user to select one of the options on the key input area 11. The input characters 21 are selection keys. As shown in FIG. 4A, the input characters 21 show different bank accounts as the selection keys for the user to select at the first option interface while the input characters 21 show different transaction options as the selection keys for the user to select at the second option interface. Accordingly, the blank keys 213 are also provided to form the combination with the selection keys. Comparing FIG. 4A with FIG. 4B, the selection keys is re-located at different touch-sensitive keys 111.

Accordingly, each of the input characters 21 displayed at the touch-sensitive keys 111 is assigned as the activation key 31, such that when one of the input characters 21 is contacted, all the input characters 21 are randomly re-located at the touch-sensitive keys 111 respectively.

Using the above mentioned option interface as an example, the activation key 31 is assigned at any one of the option keys. In other words, when the user contacts one of the bank accounts, A, B, C of the option keys, all input characters 21 are randomly re-located at the touch-sensitive keys 111 respectively at the next second option interface.

It is worth to mention that the security key inputting system 30 is adapted to incorporate with the traditional keyboard having a plurality of key buttons, wherein the input characters 21 can be re-located at different key buttons.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A touch screen device, comprising:
a touch screen panel having a key input area and defining a plurality of touch-sensitive keys at said key input area;
a control module operatively linking with said touch screen panel for displaying a plurality of input characters at said touch-sensitive keys respectively in such a manner that when one of said touch-sensitive keys is contacted, said control module identifies said corresponding input character being selected as an input data; and
a security key inputting system, which is operatively linked to said control module, randomly re-arranging said input characters at different touch-sensitive keys respectively, wherein said input characters are alternately displayed at said touch-sensitive keys for preventing said input characters from being read by memorization of fixed location.

2. The touch screen device, as recited in claim 1, wherein said security key inputting system comprises an activation key operatively linked with one of said input characters to be displayed at one of said touch-sensitive keys and arranged in such a manner that when said activation key is activated by a contact of said corresponding touch-sensitive key, said input characters are randomly re-located at said touch-sensitive keys respectively.

3. The touch screen device, as recited in claim 2, wherein said activation key is an “ENTER” key of said input character, such that when said “ENTER” key is contacted, all said input characters are randomly re-located at said touch-sensitive keys respectively.

4. The touch screen device, as recited in claim 1, wherein said input characters comprise numerical keys from 0 to 9 to be re-located at different touch-sensitive keys.

5. The touch screen device, as recited in claim 3, wherein said input characters comprise numerical keys from 0 to 9 to be re-located at different touch-sensitive keys.

6. The touch screen device, as recited in claim 2, wherein each of said input characters displayed at said touch-sensitive keys is assigned as said activation key, such that when one of said input characters is contacted, all said input characters are randomly re-located at said touch-sensitive keys respectively.

7. The touch screen device, as recited in claim 1, wherein said input characters comprise a plurality of selection keys for a list of options to be re-located at different touch-sensitive keys.

8. The touch screen device, as recited in claim 6, wherein said input characters comprise a plurality of selection keys for a list of options to be re-located at different touch-sensitive keys.

9. The touch screen device, as recited in claim 1, wherein said touch screen panel further has a key display area displaying said input characters at said touch-sensitive keys being contacted, wherein said input character is converted as a hidden symbol to be displayed at said key display area.

10. The touch screen device, as recited in claim 6, wherein said touch screen panel further has a key display area displaying said input characters at said touch-sensitive keys being contacted, wherein said input character is converted as a hidden symbol to be displayed at said key display area.

11. The touch screen device, as recited in claim 8, wherein said touch screen panel further has a key display area displaying said input characters at said touch-sensitive keys being contacted, wherein said input character is converted as a hidden symbol to be displayed at said key display area.

12. A security key inputting method for a touch screen device, comprising the steps of:
(a) initially displaying a plurality of input characters at a plurality of touch-sensitive keys at said key input area of a touch screen panel respectively, wherein when one of said touch-sensitive keys is contacted, a control module identifies said corresponding input character being selected as an input data;
(b) periodically and randomly re-arranging said input characters at different touch-sensitive keys respectively through a security key inputting system which is operatively linked to said control module; and
(c) re-locating said input characters at different touch-sensitive keys respectively, wherein said input characters are alternately displayed at said touch-sensitive keys for preventing said input characters from being read by memorization of fixed location.

13. The method as recited in claim 12, in the step (b), further comprising a default step of assigning one of said input characters to be displayed at one of said touch-sensitive keys as an activation key in such a manner that when said activation key is activated by a contact of said corresponding touch-sensitive key, said input characters are randomly re-located at said touch-sensitive keys respectively.

14. The method, as recited in claim 13, wherein said activation key is an “ENTER” key of said input character, such that when said “ENTER” key is contacted, all said input characters are randomly re-located at said touch-sensitive keys respectively.

15. The method, as recited in claim 12, wherein said input characters comprise numerical keys from 0 to 9 to be re-located at different touch-sensitive keys.

16. The method, as recited in claim 14, wherein said input characters comprise numerical keys from 0 to 9 to be re-located at different touch-sensitive keys.

17. The method as recited in claim 13, in the step (b), further comprising a default step of assigning each of said input characters displayed at said touch-sensitive keys as said activation key, such that when one of said input characters is contacted, all said input characters are randomly re-located at said touch-sensitive keys respectively.

18. The method, as recited in claim 12, wherein said input characters comprise a plurality of selection keys for a list of options to be re-located at different touch-sensitive keys.

19. The method, as recited in claim 17, wherein said input characters comprise a plurality of selection keys for a list of options to be re-located at different touch-sensitive keys.

20. The method, as recited in claim 12, further comprising a step of displaying said input characters at said touch-sensitive keys being contacted within a key display area of said touch screen panel, wherein said input character is converted as a hidden symbol to be displayed at said key display area.

21. The method, as recited in claim 16, further comprising a step of displaying said input characters at said touch-sensitive keys being contacted within a key display area of said touch screen panel, wherein said input character is converted as a hidden symbol to be displayed at said key display area.

22. The method, as recited in claim 19, further comprising a step of displaying said input characters at said touch-sensitive keys being contacted within a key display area of said touch screen panel, wherein said input character is converted as a hidden symbol to be displayed at said key display area.
